(19) United States
(12) Patent Application Publication
(10) Pub. No.: US 2026/0370081 A1
(43) Pub. Date: Nov. 19, 2026

(54) COIL UNIT FOR VACUUM APPLICATIONS

(71) Applicant: TECNOTION ASSETS B.V., Almelo (NL)

(72) Inventors: Kevin Scholten, Almelo (NL); Ralph Joseph Nick Kuijper, Almelo (NL); Marthijn Albert Kip, Almelo (NL); Lourens Vincent Van Emmerik, Almelo (NL); Roel Toon Hendrik Huinink, Almelo (NL); Thorwald Leon Van Vuure, Almelo (NL)

(21) Appl. No.: 19/153,907

(22) PCT Filed: Feb. 5, 2024
(86) PCT No.: PCT/NL2024/050055

§ 371 Date: Aug. 5, 2025

(30) Foreign Application Priority Data
Feb. 6, 2023 (NL) 2034098

(51) Int. Cl. H02K 5/22; H02K 5/08; H02K 15/148; H02K 15/32; H02K 33/18

(52) U.S. Cl. CPC H02K 5/225; H02K 5/08; H02K 15/148; H02K 15/32; H02K 33/18

(57) ABSTRACT

A coil unit and an actuator that comprises such a coil unit, a method for manufacturing the coil unit and coil units that can be used in vacuum applications. In the coil unit, an insulating plug is arranged in a feedthrough opening in the coil housing. One or more electrical connectors each extend through the insulating plug and enable an external electrical connection to be made to an electrical coil arranged inside the coil housing. The one or more electrical connectors each extend through a respective bore in the insulating plug and the one or more electrical connectors are fastened to the insulating plug using a first airtight interference fit. Furthermore, the insulating plug is fastened to the coil housing using a second airtight interference fit.

The present invention relates to a coil unit. The present invention further relates to an actuator that comprises such a coil unit and to a method for manufacturing the coil unit. The present invention particularly relates to coil units that can be used in vacuum applications.

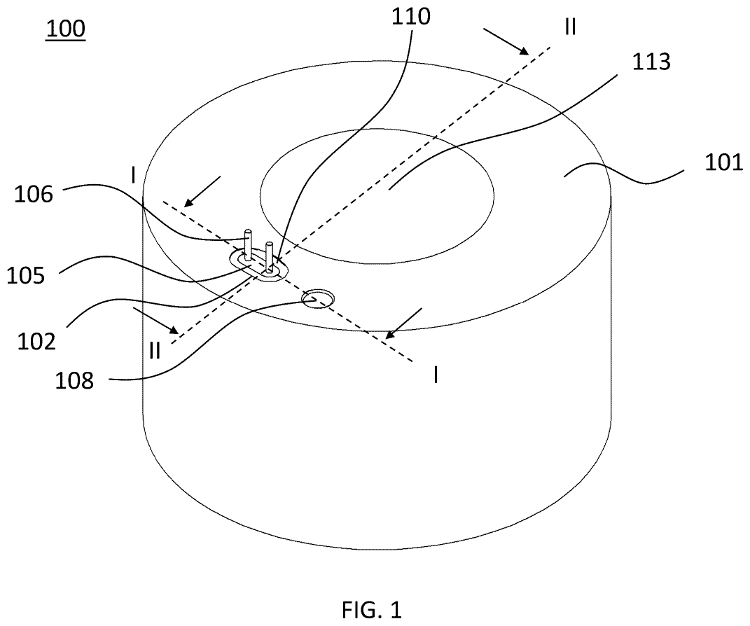

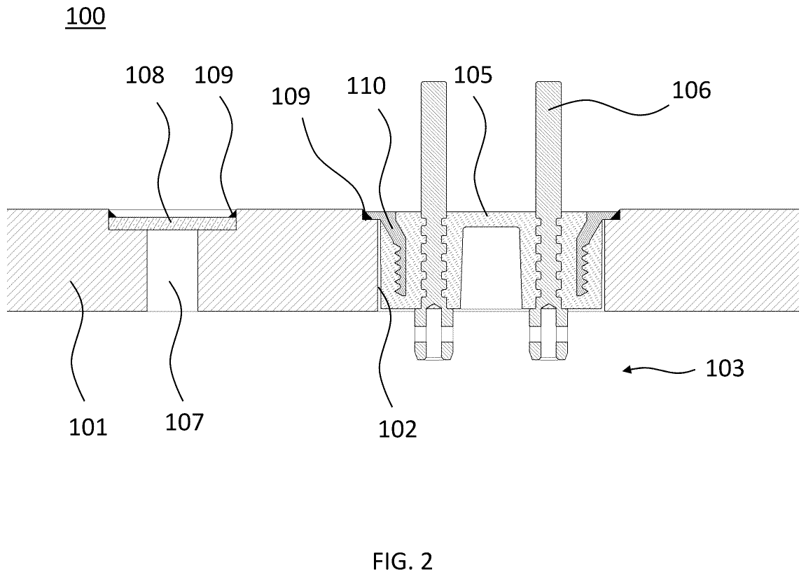

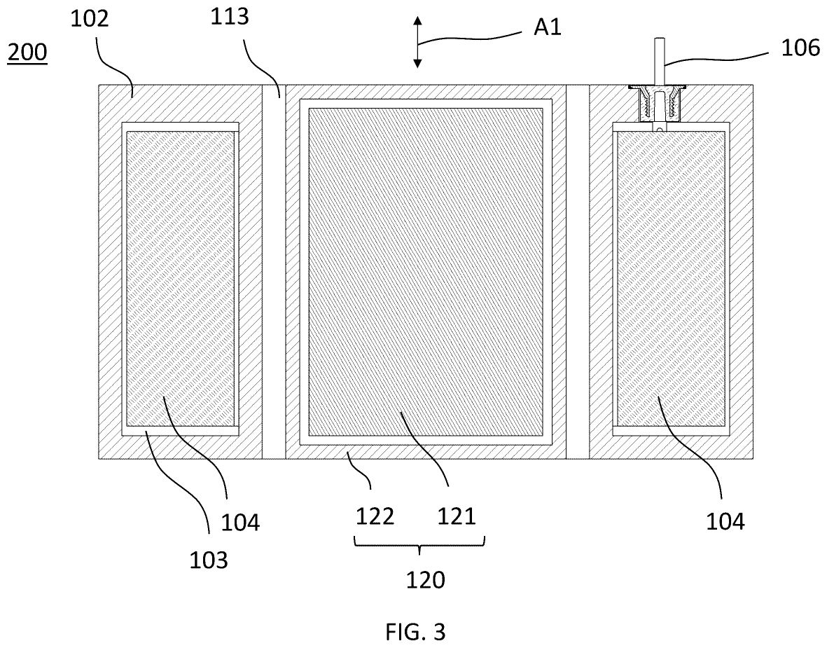

A coil unit of the type described in the preamble of claim 1 is known in the art. An example of such coil unit is depicted in FIG. 1. Further details on this coil unit are shown in FIGS. 2 and 3, which depict cross-sectional views along lines I-I and II-II, respectively.

In FIG. 1, coil unit 100 comprises a coil housing 101 that has a feedthrough opening 102 and that defines an accommodation space 103. Feedthrough opening 102 is used for allowing an electrical coil 104 arranged in accommodation space 103 to be provided with electrical power.

In known coil unit 100, an insulating plug 105 is arranged in feedthrough opening 102. Furthermore, powering electrical coil 104 is achieved using one or more electrical connectors 106 that each extend through insulating plug 105. Accommodation space 103 is closed off to limit outgassing from electrical coil 104 to outside of coil unit 100.

Now referring to FIG. 2, coil unit 100 further comprises a further opening 107 that is closed off using a plug 108 that is welded to coil housing 101. The welding process has resulted in the formation of seams 109.

Insulating plug 105 is made from a suitable polymeric material. More in particular, insulating plug 105 has been manufactured using injection molding during which electrical connectors 106 and a flange 110 were fixedly connected to a body of polymeric material 105. To improve adhesion of flange 110 and connectors 106 to the body of polymeric material, edges thereof are corrugated as shown in FIG. 2. To fixedly attach insulating plug 105 to coil housing 102, a welding technique is used for welding flange 110 to coil housing 101 thereby producing a welding seam 109. Typically, coil housing 101, flange 110 and plug 108 are made from stainless steel.

FIG. 3 illustrates coil unit 100 in combination with a magnet unit 120 that comprises a permanent magnet 121 that is arranged inside a magnet housing 122. Similar to accommodation space 103, the space inside magnet unit 120 in which permanent magnet 121 is arranged is closed off to prevent outgassing.

Coil unit 100 is hollow and is provided with a central bore 113 in which magnet unit 120 is at least partially arranged. Together, coil unit 100 and magnet unit 120 form a voice coil actuator 200. When powering electrical coil 104, a relative motion between magnet unit 120 and coil unit 100 as indicated by arrow Al is generated.

Voice coil actuators of the type shown in FIG. 3 can be used in vacuum applications. In such applications, it is important that the outgassing of components is minimized. For permanent magnet 121 this can be achieved by constructing magnet housing 122 using different parts that are welded together. For example, magnet housing 122 may comprise a first part to which permanent magnet 121 is attached and a second part that is welded to the first part thereby sealing off the space inside magnet housing 122.

A similar approach can be used for coil unit 100. For example, coil unit 100 can be manufactured by using two or more parts for coil housing 102. A first part may be connected to insulating plug 105 using a welding technique. Electrical coil 104 may be mounted in a second part. Thereafter, electrical connection can be made between connectors 106 and electrical coil 104 and the first part and second part can be fixedly attached to each other using a welding technique. Once attached, a Helium leak test can be performed through opening 107. If coil unit 100 passes this test, opening 107 is closed using plug 108.

The Applicant has found that coil units of the type described above often display too much outgassing for modern day high vacuum or ultra-high vacuum applications.

It is an object of the present invention to provide a coil unit that displays no to limited outgassing.

According to the present invention, this object is achieved using the coil unit as defined in claim 1, which is characterized in that the one or more electrical connectors each extend through a respective bore in the insulating plug and in that the one or more electrical connectors are fastened to the insulating plug using a first airtight interference fit, and wherein the insulating plug is fastened to the coil housing using a second airtight interference fit.

The Applicant has found that leakage in known coil units may arise as a result of the insulating plug having been subjected to different heating steps. A first heating step is for example the injection molding by which the connectors and flange are connected to a polymeric body. A second heating step is the welding of the insulating plug to the coil housing. The Applicant considers that these heating steps causes minor clearances to be formed between the flange and the polymeric body and/or between the connectors and the polymeric body. When used in vacuum environments, outgassing may occur through these clearances.

According to the present invention, the use of heating steps is minimized. Firstly, the one or more electrical connectors are fastened to the insulating plug using a first airtight interference fit. Within the context of the present invention, an interference fit is a fit between a first component having an opening, through hole, bore or the like, in which a second component is arranged. The inner size of the opening, through hole, bore or the like is smaller than the outer size of the second component. Accordingly, at least one of the insulating plug and the one or more electrical connectors will deform when arranging the one or more electrical connectors in the insulating plug.

Secondly, the insulating plug is fastened to the coil housing using a second airtight interference fit. Here, the inner size of the feedthrough opening is smaller than the outer size of the insulating plug. Accordingly, at least one of the insulating plug and the coil housing will deform when arranging the insulating plug in the coil housing.

The first airtight interference fit can be configured to prevent outgassing through a space between the insulating plug and the one or more electrical connectors and the second airtight interference fit can be configured to prevent outgassing through a space between the insulating plug and the coil housing. For example, as a result of the abovementioned deformation, the one or more electrical connectors, the coil housing, and/or the insulating plug will have residual stress enabling an airtight connection to be achieved.

Typically, the one or more electrical connectors and coil housing are made of stainless steel. This causes most if not all deformation to occur in the insulating plug. For example, the insulating plug may have, near the first interference fit, a strain in a range between 0.5 and 10 percent, and a stress in a range between 10 and 200 percent of the yield strength. Additionally or alternatively, the insulating plug may have, near the second interference fit, a strain in a range between 0.3 and 5 percent, and a stress in a range between 10 and 200 percent of the yield strength.

The insulating plug can be made from a polymeric material. For example, the polymeric material may comprise at least one polymer from the group consisting of polyether ether ketone, PEEL, polyimide, polyethylene, nitrile butadiene rubber, and fluoropolymers such as polytetrafluoroethylene, polyvinylidene fluoride, and ethylenechlorotrifluoroethylene.

The one or more electrical connectors may comprise a first pin and a second pin arranged spaced apart from and preferably parallel to the first pin. At least one of the one or more electrical connectors may have a chamfered end, and/or at least one respective bore may have a chamfered edge, and/or the feedthrough opening may have a chamfered edge, and/or an outer surface of the insulating plug may have a chamfered edge. Using chamfering, the interference fit can be realized more readily as it allows a small part of the one or more electrical connectors to be arranged in the respective bore(s) without the one or more electrical connectors and/or respective bore(s) needing to deform. This particularly holds when the chamfering of the one or more electrical connectors and the chamfering of the respective bore(s) is such that near the end(s), the outer size(s) of the one or more electrical connectors is less than the inner size(s) of the respective bore(s). Similar considerations apply for the outer surface of the insulating plug and the feedthrough opening.

At least one respective bore may be formed by a respective wall of the insulating plug that has a tapered form that matches a tapered form of the corresponding electrical connector. Similarly, an outer wall of the insulating plug may have a tapered form that matches a tapered form of a wall of the coil housing that defines the feedthrough opening. The tapering allows for relaxed requirements for the sizes and shapes of the respective bore(s) and feedthrough opening. Furthermore, the tapering angle and length can be chosen to find a balance between ease of insertion and the outgassing limit that can be obtained.

The coil housing may comprise a further feedthrough opening, and the coil unit may further comprise a further insulating plug arranged in the further feedthrough opening, wherein the further insulating plug is fastened to the coil housing using a third airtight interference fit. This third airtight interference fit is preferably configured as the second airtight interference fit.

The further feedthrough opening can be used to perform Helium leak tests. After having completed these tests, the further feedthrough opening is closed using the further insulating plug.

According to a second aspect, the present invention provides an actuator that comprises the coil unit as defined above and a magnet unit comprising a permanent magnet. The actuator is configured to cause relative motion between the coil unit and the magnet when powering the coil in the coil unit.

The coil housing of the coil unit can be hollow and can be provided with a central bore in which the permanent magnet is at least partially and movably arranged. For example, the coil housing can be shaped as a hollow cylinder, hollow bar or beam, or as a doughnut.

The actuator may be a voice coil actuator, although the present invention equally relates to other linear motors or rotating motors. Additionally or alternatively, the magnet unit may further comprise a magnet housing in which the permanent magnet is arranged. The space inside the magnet housing in which the permanent magnet is arranged is closed off to limit outgassing from the permanent magnet to outside the magnet unit.

According to a third aspect, the present invention provides a method for manufacturing the coil unit as defined above. This method comprises the steps of providing a first part of a coil housing having a feedthrough opening and providing an insulating plug having one or more bores. The method further comprises the steps of forming a first airtight interference fit by press-fitting each electrical connector of one or more electrical connectors through a respective bore in the insulating plug and subsequently forming a second airtight interference fit by press-fitting the insulating plug into the feedthrough opening.

According to a fourth aspect, the present invention provides a method for manufacturing the coil unit as defined above. This method comprises the steps of providing a first part of a coil housing having a feedthrough opening and providing an insulating plug having one or more bores. The method further comprises the steps of forming a second airtight interference fit by press-fitting the insulating plug in the feedthrough opening and subsequently forming a first airtight interference fit by press-fitting each electrical connector of one or more electrical connectors through a respective bore in the insulating plug that is arranged in the feedthrough opening.

According to a fifth aspect, the present invention provides a method for manufacturing the coil unit as defined above. This method comprises the steps of providing a first part of a coil housing having a feedthrough opening and providing an insulating plug having one or more bores. The method further comprises forming a second airtight interference fit by press-fitting the insulating plug in the feedthrough opening and simultaneously forming a first airtight interference fit by press-fitting each electrical connector of one or more electrical connectors through a respective bore in the insulating plug.

The method according to the third, fourth, and fifth aspect may also comprise providing a second part of a coil housing, attaching an electrical coil to at least one of the first and second parts of the coil housing, electrically connecting the electrical coil to the one or more electrical connectors, and fixedly attaching the first and second parts of the coil housing thereby creating an accommodation space in which the electrical coil is arranged, which accommodation space is closed off to limit outgassing from the electrical coil to outside the coil unit.

In the above, a coil unit is described that has an insulating plug, wherein one or more electrical connectors extend through the insulating plug. It should be noted that the present invention equally relates to coil units that have more than one insulating plug that each have one or more electrical connectors extending through them.

Next, the present invention will be described in more detail referring to the appended drawings, wherein:

FIGS. 1 and 2 illustrate a known coil unit;

FIG. 3 illustrates a known voice coil actuator that comprises the coil unit of FIG. 1;

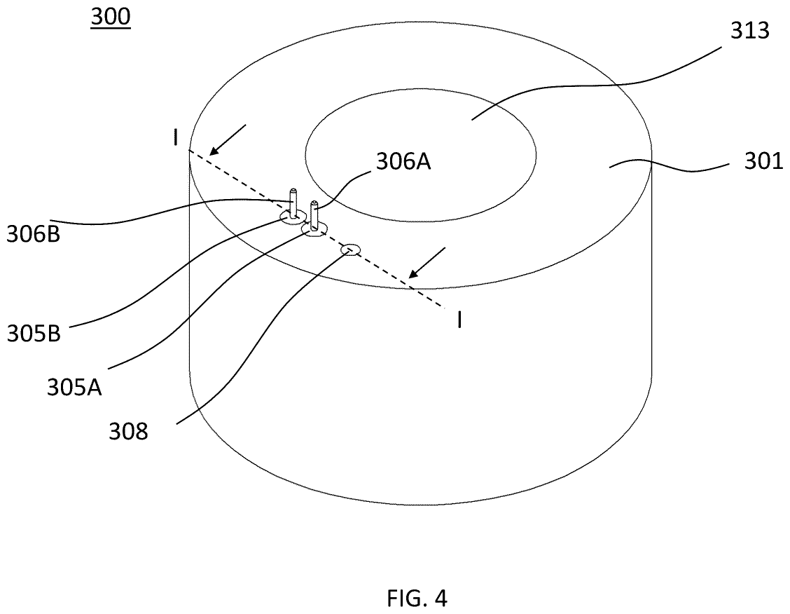

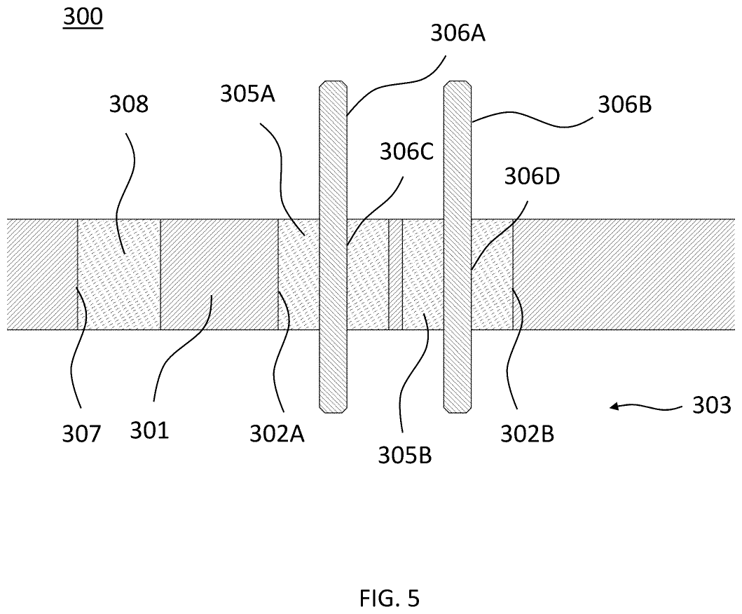

FIGS. 4 and 5 illustrate a first embodiment of a coil unit according to the present invention;

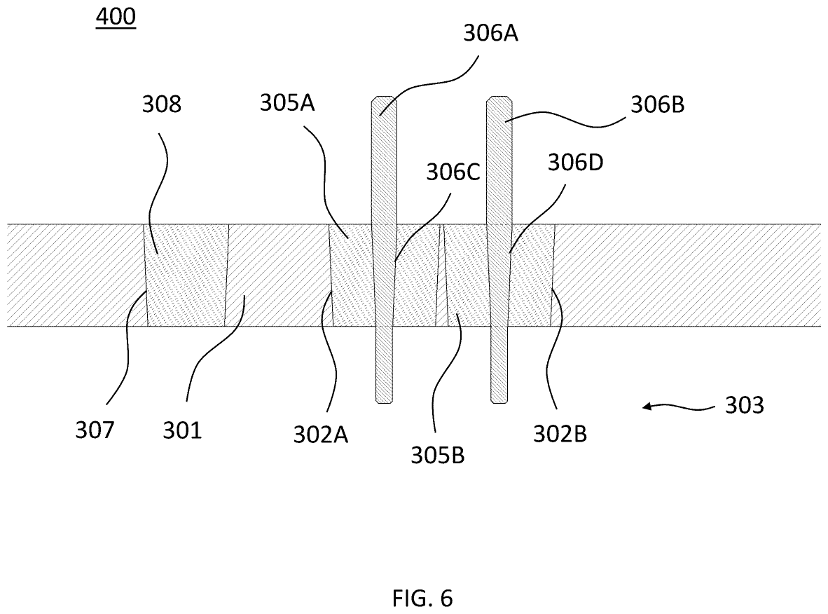

FIG. 6 illustrates a second embodiment of a coil unit according to the present invention;

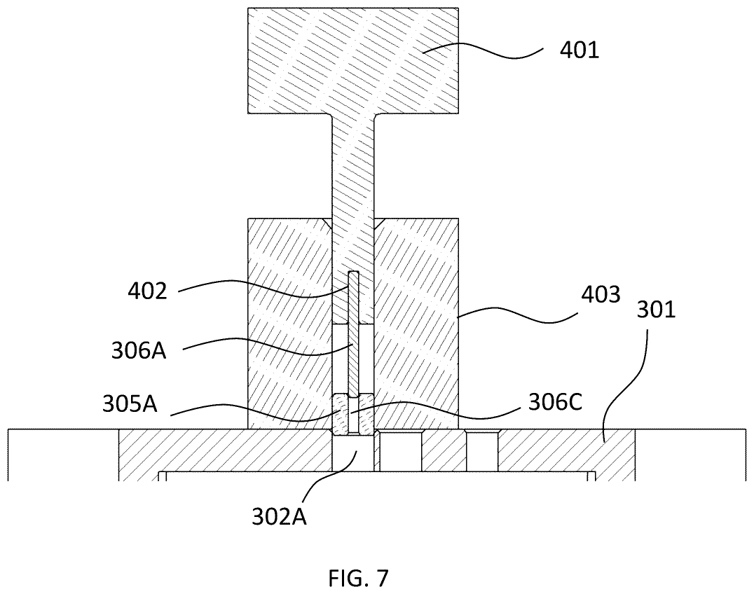

FIG. 7 illustrates a first method of manufacturing the coil unit of FIG. 4; and

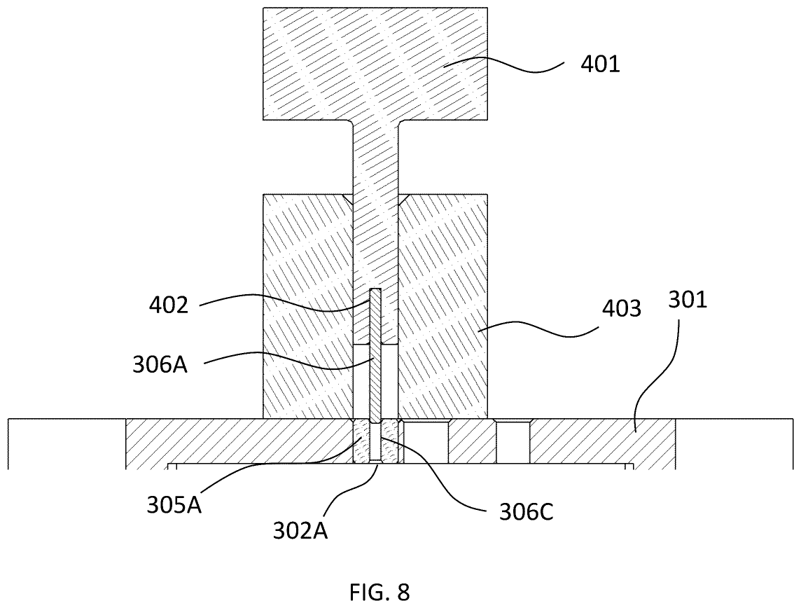

FIG. 8 illustrates a second method of manufacturing the coil unit of FIG. 4.

An embodiment of a coil unit 300 in accordance with the present disclosure is shown in perspective view in FIG. 4. FIG. 5 presents a cross-sectional view of coil unit 300 taken along line I-I in FIG. 4.

Coil unit 300 comprises a coil housing 301 that has feedthrough openings 302A, 302B. Coil housing 301 defines an accommodation space 303 in which an electrical coil is arranged similar to electrical coil 104 shown in FIG. 3.

Insulating plugs 305A, 305B are arranged in feedthrough openings 302A, 302B, respectively. Insulating plugs 305A, 305B are preferably made from polyether ether ketone, PEEK. However, the present invention does not exclude the use of other polymers such as polyimide, polyethylene, nitrile butadiene rubber, and fluoropolymers such as polytetrafluoroethylene, polyvinylidene fluoride, and ethylenechlorotrifluoroethylene.

A first pin 306A and a second pin 306B extend through insulating plug 305A, 305B, respectively. First ends 306A1, 306B1 of pins 306A, 306B can be connected to an external power source, and second ends 306A2, 306B2 of pins 306A, 306B can be connected to the electrical coil.

Accommodation space 303 is closed off to limit outgassing from electrical coil 304 to outside of coil unit. For example, coil housing 301 can be made of two or more parts that are welded together to form accommodation space 303. By attaching the electrical coil to one or more of these parts before fixedly connecting these parts together in a sealed manner, the electrical coil can be arranged in accommodation space 303.

Comparing FIG. 5 to FIG. 2 indicates that according to the present invention no welding spots or seams are visible between insulating plugs 305A, 305B and coil housing 301. Instead, insulating plugs 305A, 305B are arranged inside feedthrough openings 302A, 302B using an interference fit. More in particular, the interference fit is airtight allowing coil unit 300 to be used in vacuum applications.

In the known coil unit of FIG. 2, pins 106 were provided inside insulating plug 105 using an injection molding process in which a polymeric material is molded around pins 106. According to the present invention, pins 306A, 306B are arranged in respective bores 306C, 306D inside insulating plug 305A, 305B. Insulting plugs 305A, 305B are formed as stand-alone components using a technique such as injection molding. Bores 306C, 306D are either formed in a molded body of polymeric material or are formed during the injection molding process.

The fastening of pins 306A, 306B in bores 306C, 306D is based on an interference fit. Similar to the interference fit between insulating plugs 305A, 305B and coil housing 301, this interference fit should be airtight as well.

For example, coil unit 300 can be configured to be used in vacuum applications, such as a linear motor and more in particular a voice coil actuator, wherein a vacuum level in a range between 10⁻⁶ and 10⁻³ Pa is used, wherein the outgassing rate measured 1 hours after start of pumping is below 10⁻⁶ mbar·1·s⁻¹·cm⁻² and more preferably below 10⁻⁸ mbar·1·s⁻¹·cm⁻² averaged over the entire outside surface of the actuator.

Also shown in FIGS. 4 and 5 is an opening 307 that allows a leak test to be performed directly after manufacturing. As shown, in the finalized product, opening 307 is closed off with a plug 308 that can be equally made of PEEK.

Coil unit 300 can be used in a voice coil actuator as shown in FIG. 4. More specifically, coil unit 300 comprises a central bore 313 in which a magnet unit can be arranged identical to magnet unit 120 shown in FIG. 3.

In FIGS. 4 and 5, two insulating plugs 305A, 305B are shown for feeding through two pins 306A, 306B, respectively. The present invention is not limited to using separate plugs for each pin. For single a single polymeric body having two spaced apart bores could be used for pins 306A, 306B.

FIG. 6 illustrates a modification of coil unit 300, wherein the same reference signs are used as in FIG. 5 to refer to identical or similar components. Comparing coil unit 400 of FIG. 6 to coil unit 300 of FIG. 5 shows that openings 307, 302A, 302B, and bores 306C, 306D have a tapered form and more specifically have a conical shape. A complementary shape is used for plugs 305A, 305B, 308 and pins 306A, 306B.

The tapering angle of pins 306A, 306B and the tapering angle of plugs 305A, 305B, 308 influence the distribution of stress and strain in the material of plugs 305A, 305B, 308 and can be chosen for the most secure leak-tight connection, or for easiest insertion. Additional advantages of having tapered pins 306A, 306B and tapered plugs 305A, 305B, 308 are the reduced requirements on the tolerances on the diameter and roundness.

In the above, interference fits have been described between the pins and the insulating plugs, and between the insulating plugs and the coil housing. In an interference fit, the object that is arranged into an opening of another object has a larger size than the size of the opening such that at least one of the objects has to deform. Such deformation typically comprises a plastic component in addition to an elastic component. As a result of the deformation, strain will exist in at least one of these components. This strain enables an airtight sealing of the accommodation space. The Applicant has found that PEEK provides a suitable material for achieving the balance between plastic deformation, elastic deformation, and the airtightness of the sealing of the accommodation space, although the use of other materials is not excluded.

For at least some coil units according to the present invention, including those indicated in FIGS. 4-6, the insulating plug, near the interference fit with the one or more electrical connectors, has a strain in a range between 0.5 and 10 percent, and a stress in a range between 10 and 200 percent of the yield strength. Similarly, the insulating plug, near the interference fit with the coil housing, has a strain in a range between 0.3 and 5 percent, and a stress in a range between 10 and 200 percent of the yield strength.

The Applicant has found that connecting the pins to the insulating plugs using a first interference fit and connecting the insulating plug to the coil housing using a second interference fit in the manner described above allows the coil unit to be used in strong vacuum applications.

FIGS. 7 and 8 illustrate two examples of how the insulating plugs and pins can be arranged in the coil housing. More in particular, these figures focus on arranging insulating plug 305A and pin 306C in feedthrough opening 302A.

It should be noted that the coil housing, at the time of arranging the insulating plug(s), may still consist of different parts that are not yet connected. For example, the coil housing may comprise a bottom part, to which the electrical coil is fastened, and a top part in which the insulating plugs and pins are arranged. In this case, wiring is connected between the electrical coil and the pins after having arranged the pins in the insulating plugs. This situation is shown in FIGS. 7 and 8, wherein the part referred to using reference sign 301 corresponds to the top part of the coil housing.

FIGS. 7 and 8 further illustrate a pressing member 401 that comprises a cavity 402 in which pin 306A can be received. Pressing member 401 is guided by guiding member 403 by which also alignment is achieved relative to feedthrough opening 302A in coil housing 301.

Several different options exist for arranging pin 306A in insulating plug 305A and arranging insulating plug 305A in feedthrough opening 302A. In a first option, shown in FIG. 7, a pin 306A is arranged in cavity 402 and insulating plug 305A is arranged inside guide member 403. By pressing down pressing member 401 relative to guide member 403 and assuming that the friction between insulating plug 305A and guide member 403 is greater than the friction between pin 306A and insulating plug 305A, pin 306A is inserted into bore 306C without or with limited movement of insulating plug 305A. By pressing down pressing member 401 even further, it will itself engage insulating plug 305A and press it into feedthrough opening 302A.

In a second option, shown in FIG. 8, pin 306A is arranged in cavity 402 and insulating plug 305A is already arranged in feedthrough opening 302A, for example using pressing member 401 in a previous step. By pressing down pressing member 401 relative to guide member 403 and assuming that the friction between insulating plug 305A and coil housing 301 is greater than the friction between pin 306A and insulating plug 305A, pin 306A is inserted into bore 306C without or with limited movement of insulating plug 305A.

In the above, the invention has been described by referring to an electrical coil being arranged in the coil housing and by referring to a permanent magnet being arranged in the magnet housing. It should be clear to the skilled person that the present invention equally relates to embodiments in which multiple electrical coils are arranged in the coil housing as to embodiments in which a single electrical coil is arranged in the coil housing. Similarly, the present invention equally relates to embodiments in which multiple permanent magnets are arranged in the magnet housing as to embodiments in which a single permanent magnet is arranged in the magnet housing.

In the above, the present invention has been described using detailed embodiments thereof. It should however be noted that the present invention is not limited to these embodiments and that several modifications are possible without departing from the scope of the present invention which is defined by the appended claims and their equivalents.

1. A coil unit (300, 400), comprising:
a coil housing (301) having a feedthrough opening (302A, 302B) and defining an accommodation space (303);
an electrical coil (304) arranged in the accommodation space (303);
an insulating plug (305A, 305B) arranged in the feedthrough opening (302A, 302B);
one or more electrical connectors (306A, 306B) that each extend through the insulating plug (305A, 305B) and that enable an external electrical connection to be made to the electrical coil (304);
wherein the accommodation space (303) is closed off to limit outgassing from the electrical coil (304) to outside the coil unit (300, 400);
characterized in that the one or more electrical connectors (306A, 306B) each extend through a respective bore (306C, 306D) in the insulating plug (305A, 305B) and in that the one or more electrical connectors (306A, 306B) are fastened to the insulating plug (305A, 305B) using a first airtight interference fit, and wherein the insulating plug (305A, 305B) is fastened to the coil housing (301) using a second airtight interference fit.

2. The coil unit (300, 400) according to claim 1, wherein the first airtight interference fit is configured to prevent outgassing through a space between the insulating plug (305A, 305B) and the one or more electrical connectors (306A, 306B).

3. The coil unit (300, 400) according to claim 1, wherein the second airtight interference fit is configured to prevent outgassing through a space between the insulating plug (305A, 305B) and the coil housing (301).

4. The coil unit (300, 400) according to claim 1, wherein the insulating plug (305A, 305B), near the first interference fit, has a strain in a range between 0.5 and 10 percent, and a stress in a range between 10 and 200 percent of the yield strength.

5. The coil unit (300, 400) according to claim 1, wherein the insulating plug (305A, 305B), near the second interference fit, has a strain in a range between 0.3 and 5 percent, and a stress in a range between 10 and 200 percent of the yield strength.

6. The coil unit (300, 400) according to claim 1, wherein the insulating plug (305A, 305B) is made from a polymeric material,
wherein the polymeric material comprises at least one polymer from the group consisting of polyether ether ketone, polyimide, polyethylene, nitrile butadiene rubber, and fluoropolymers.

7. (canceled)

8. The coil unit (300, 400) according to claim 1, wherein the one or more electrical connectors (306A, 306B) comprise a first pin (306A) and a second pin (306B) arranged spaced apart from and parallel to the first pin (306A).

9. The coil unit (300, 400) according claim 1, wherein at least one of the one or more electrical connectors (306A, 306B) has a chamfered end, and/or wherein at least one respective bore (306C, 306D) has a chamfered edge, and/or wherein an outer surface of the insulating plug (305A, 305B) has a chamfered edge, and/or wherein the feedthrough opening (302A, 302B) has a chamfered edge.

10. The coil unit (400) according to claim 1, wherein at least one respective bore (306C, 306D) is formed by a respective wall of the insulating plug (305A, 305B) that has a tapered form that matches a tapered form of the corresponding electrical connector (306A, 306B).

11. The coil unit (400) according to claim 1, wherein an outer wall of the insulating plug (305A, 305B) has a tapered form that matches a tapered form of a wall of the coil housing (301) that defines the feedthrough opening (302A, 302B).

12. The coil unit (300, 400) according to claim 1, wherein the coil housing (301) comprises a further feedthrough opening (307), and wherein the coil unit (300, 400) further comprises a further insulating plug (308) arranged in the further feedthrough opening (307), wherein the further insulating plug (308) is fastened to the coil housing (301) using a third airtight interference fit, wherein the third airtight interference fit is configured as the second airtight interference fit.

13. An actuator, comprising:
the coil unit (300, 400) as defined in claim 1; and
a magnet unit (120) comprising a permanent magnet (121);
wherein the actuator is configured to cause relative motion between the coil unit (300, 400) and the magnet unit (120) when powering the electrical coil (304) in the coil unit (300, 400).

14. The actuator according to claim 13, wherein the coil housing (301) of the coil unit (300, 400) is hollow and is provided with a central bore (313) in which the magnet unit (120) is at least partially and movably arranged.

15. The actuator according to claim 14, wherein the coil housing (301) is shaped as a hollow cylinder, hollow bar or beam, or as a doughnut.

16. The actuator according to claim 13, wherein the actuator is a voice coil actuator.

17. The actuator according to claim 13, wherein the magnet unit (120) further comprises a magnet housing (122) in which the permanent magnet (121) is arranged.

18. A method for manufacturing the coil unit as defined in claim 1, comprising:
providing a first part of a coil housing having a feedthrough opening;
providing an insulating plug having one or more bores; and
forming a first airtight interference fit by press-fitting each electrical connector of one or more electrical connectors through a respective bore in the insulating plug and subsequently forming a second airtight interference fit by press-fitting the insulating plug in the feedthrough opening

19. A method for manufacturing the coil unit as defined in claim 1, comprising:
providing a first part of a coil housing having a feedthrough opening;
providing an insulating plug having one or more bores;
forming a second airtight interference fit by press-fitting the insulating plug in the feedthrough opening and subsequently forming a first airtight interference fit by press-fitting each electrical connector of one or more electrical connectors through a respective bore in the insulating plug.

20. A method for manufacturing the coil unit as defined in claim 1, comprising:
providing a first part of a coil housing having a feedthrough opening;
providing an insulating plug having one or more bores;
forming a second airtight interference fit by press-fitting the insulating plug in the feedthrough opening and simultaneously forming a first airtight interference fit by press-fitting each electrical connector of one or more electrical connectors through a respective bore in the insulating plug.

21. The method according to claim 18, further comprising:
providing a second part of a coil housing;
attaching an electrical coil to at least one of the first and second parts of the coil housing;
electrically connecting the electrical coil to the one or more electrical connectors; and
fixedly attaching the first and second parts of the coil housing thereby creating an accommodation space in which the electrical coil is arranged, which accommodation space is closed off to limit outgassing from the electrical coil to outside the coil unit.
